(19) United States
(12) Patent Application Publication
(10) Pub. No.: US 2024/0178694 A1
(43) Pub. Date: May 30, 2024

(54) SMART CHARGING METHOD AND ELECTRONIC DEVICE USING THE SAME

(71) Applicant: Acer Incorporated, New Taipei City (TW)

(72) Inventors: Shu-Wei YEH, New Taipei City (TW); Chuan-Jung WANG, New Taipei City (TW)

(73) Assignee: Acer Incorporated, New Taipei City (TW)

(21) Appl. No.: 18/524,732

(22) Filed: Nov. 30, 2023

(30) Foreign Application Priority Data
Nov. 30, 2022 (TW) 111146014

(51) Int. Cl. H02J 7/00

(52) U.S. Cl. CPC H02J 7/00712; H02J 7/0048

(57) ABSTRACT

A smart charging method and an electronic device using the same are provided. The smart charging method includes the following steps. Whether an electronic device is connected to a charger is determined. If the battery is connected to the charger, whether a current time is within a predetermined idle period is determined. If the current time is within the predetermined idle period, a battery of the electronic device is charged at a charge rate less than 0.8C by constant current charging, which lasts for a predetermined constant current charging time. After the predetermined constant current charging time is over, the battery is idled for a predetermined idle time. After the predetermined idle time is over, the battery is charged by constant voltage charging.

This application claims the benefit of Taiwan application Serial No. 111146014, filed Nov. 30, 2022, the subject matter of which is incorporated herein by reference.

### BACKGROUND OF THE INVENTION

### Field of the Invention

The invention relates in general to a control method and an electronic device using the same, and more particularly to a smart charging method and an electronic device using the same.

### Description of the Related Art

For the convenience of portability, many electronic devices are equipped with a battery for providing power. However, due to different users' usage habits, the battery will operate under different working environments (the voltage during storage, the temperature during operation, the magnitude of charging/discharging current, and so on), which indirectly cause different degree of aging to the battery and affect its lifespan.

For instance, some users are used to plug a power supply to a laptop computer for a long period of time and use the laptop computer as a desktop computer, making the battery remain in a high voltage state over a long period of time. Under such circumstance, battery aging will be accelerated, and the lifespan will be reduced. To prolong the lifespan of a battery, the research personnel are devoted to the development of a smart charging method and provide a battery healthy charging mode with which the lifespan of a battery can be prolonged.

### SUMMARY OF THE INVENTION

The invention is directed to a smart charging method and an electronic device using the same. In the method, a constant current charging procedure with a low charge rate is adopted. The constant voltage charging procedure is arranged to the last, so that the battery will not remain at full capacity for long in a healthy charging mode and the lifespan can be prolonged.

According to one embodiment of the present invention, a smart charging method is provided. The smart charging method includes the following steps. Whether an electronic device is connected to a charger is determined. If the battery is connected to the charger, whether a current time is within a predetermined idle period is determined. If the current time is within the predetermined idle period, a battery of the electronic device is charged at a charge rate less than 0.8C by constant current charging, which lasts for a predetermined constant current charging time. After the predetermined constant current charging time is over, the battery is idled for a predetermined idle time. After the predetermined idle time is over, the battery is charged by constant voltage charging.

According to another embodiment of the present invention, an electronic device is provided. The electronic device includes a power connection port, a battery, a charging unit and a power management unit. The power connection port is connected to a charger. The charging unit is connected to the battery. The charging unit is configured to charge the battery. The power management unit is connected to the power connection port and the battery. The power management unit includes a connection port detection circuit, a time determination circuit and a control circuit. The connection port detection circuit is configured to determine whether the power connection port is connected to the charger. The control circuit is configured to control the charging unit. If the power connection port is connected to the charger, the time determination circuit determines whether a current time is within a predetermined idle period. If it is determined that the current time is within the predetermined idle period, the control circuit outputs a constant current control signal to the charging unit for enabling the charging unit to charge the battery at a charge rate less than 0.8C by constant current charging, which lasts for a predetermined constant current charging time. After the time determination circuit determines that the predetermined constant current charging time is over, the control circuit outputs an idle signal to the charging unit for enabling the charging unit to idle the battery for a predetermined idle time. After the time determination circuit determines that the predetermined idle time is over, the control circuit outputs a constant voltage control signal to the charging unit for enabling the charging unit to charge the battery by constant voltage charging.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of an electronic device according to an embodiment.

FIG. 2 is a schematic diagram of the usage period of an electronic device in a day according to an embodiment.

FIG. 3 is a schematic diagram of the usage period of an electronic device in a day according to another embodiment.

FIG. 4 is a schematic diagram of a battery management mode of an electronic device according to an embodiment.

FIG. 5 is an exemplification of predetermined total charging time.

FIG. 6 is an exemplification of a comparison between an ordinary charging mode and a healthy charging mode according to an embodiment.

FIG. 7 is a charging curve diagram of an ordinary charging mode and a healthy charging mode according to an embodiment.

FIG. 8 is a block diagram of an electronic device according to an embodiment.

FIG. 9 is a flowchart of a smart charging method according to an embodiment.

FIG. 10 is another exemplification of predetermined total charging time.

FIG. 11 is an exemplification of a comparison between an ordinary charging mode and a healthy charging mode according to another embodiment.

FIG. 12 is an exemplification of a charging curve diagram of an ordinary charging mode and a healthy charging mode according to another embodiment.

### DETAILED DESCRIPTION OF THE INVENTION

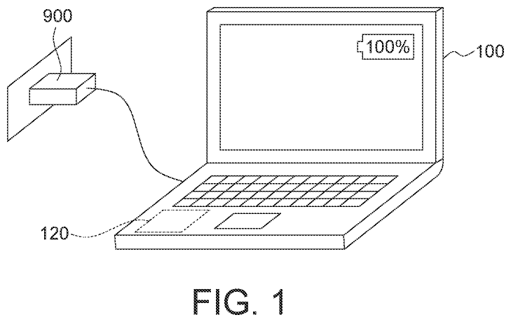

Referring to FIG. 1, a schematic diagram of an electronic device 100 according to an embodiment is shown. The electronic device 100 can be realized by a laptop computer, a mobile phone, a tablet, a game console or an e-reader. If the electronic device 100 is connected to a charger 900 but the charger 900 is not unplugged timely after the battery 120 of the electronic device 100 is fully charged, the battery 120 will remain at full capacity for long. Under such circumstance, the lifespan of the battery 120 will be reduced.

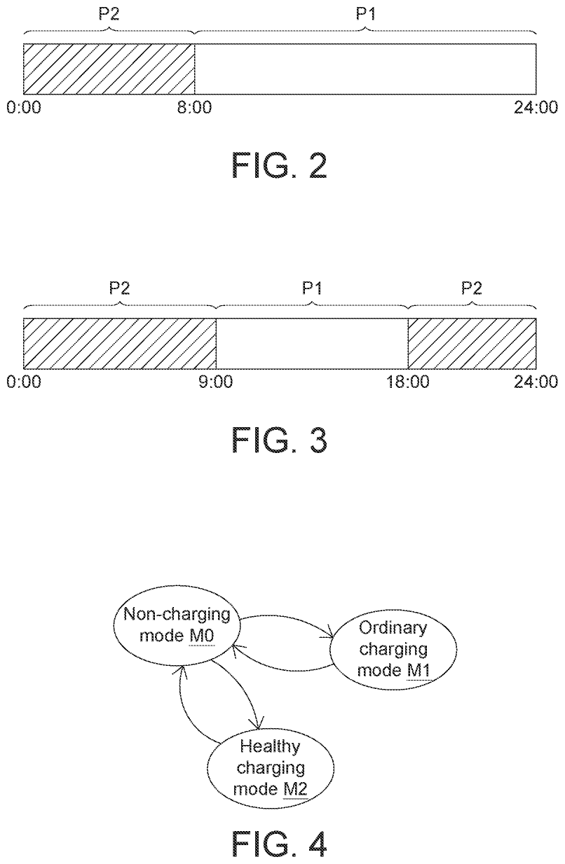

Referring to FIG. 2, a schematic diagram of usage period of an electronic device 100 in a day according to an embodiment is shown. For some users, they always carry the electronic device 100 with them wherever they go. They may use the electronic device 100 in the morning, afternoon, and evening (such as from 08.00 to 24.00) except for the nighttime (such as from 00.00 to 08.00). In the present example, the morning, afternoon, and evening can be defined as a predetermined busy period P1; the nighttime can be defined as a predetermined idle period P2.

Referring to FIG. 3, a schematic diagram of the usage period of an electronic device 100 in a day according to another embodiment is shown. For some users, they use the electronic device 100 only at the workplace. They use the electronic device 100 in the worktime (such as from 09.00 to 18.00) only; they do not use the electronic device 100 at the nighttime (such as from 18.00 to 09.00). In the present example, the worktime can be defined as a predetermined busy period P1; the nighttime can be defined as a predetermined idle period P2.

Referring to FIG. 4, a schematic diagram of a battery management mode of an electronic device 100 according to an embodiment is shown. In the present embodiment, the battery 120 has three battery management modes, namely, “non-charging mode M0”, “ordinary charging mode M1” and “healthy charging mode M2”. Before the charger 900 is plugged into the electronic device 100, the battery 120 is in the non-charging mode M0; when the charger 900 is plugged into the electronic device 100 within the predetermined busy period P1, the battery 120 can be controlled to remain in the ordinary charging mode M1; when the charger 900 is plugged into the electronic device 100 within the predetermined idle period P2, the battery 120 can be controlled to remain in the healthy charging mode M2.

In the ordinary charging mode M1, an ordinary charging method can be performed first. For instance, the battery 120 is charged at a charge rate of 1C by constant current charging, then the battery 120 changes to be charged by constant voltage charging to quickly replenish the capacity of the battery 120.

In the healthy charging mode M2, a smart charging method can be performed. For instance, the battery 120 is charged at a charge rate of 0.2C by constant current charging, and then the battery 120 which is not yet fully charged is idled for a period of time before the battery 120 is charged by constant voltage charging, so that the battery 120 will not remain at full capacity for long.

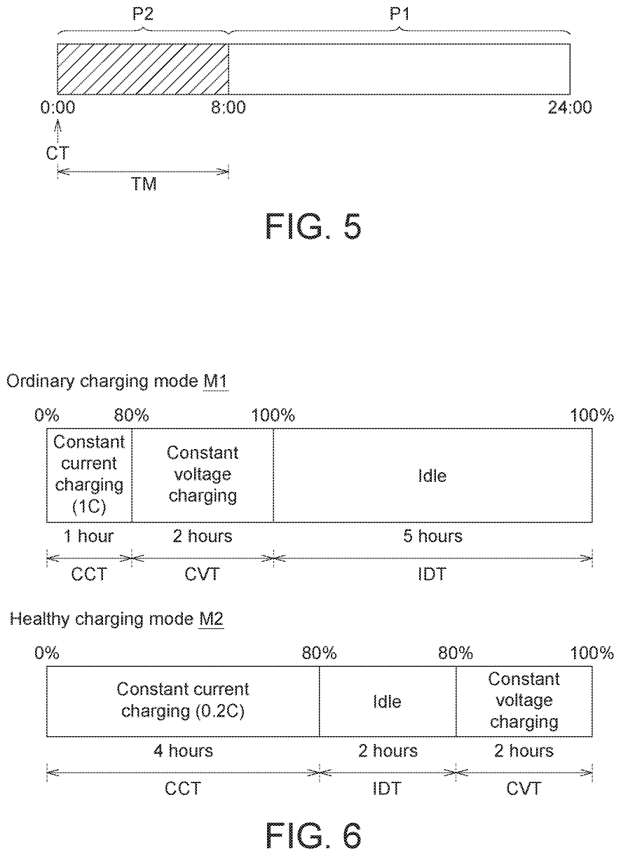

FIG. 5 is an exemplification of predetermined total charging time TM. If the current time CT is 00.00, then the predetermined total charging time TM allowing charging within the predetermined idle period P2 is 8 hours.

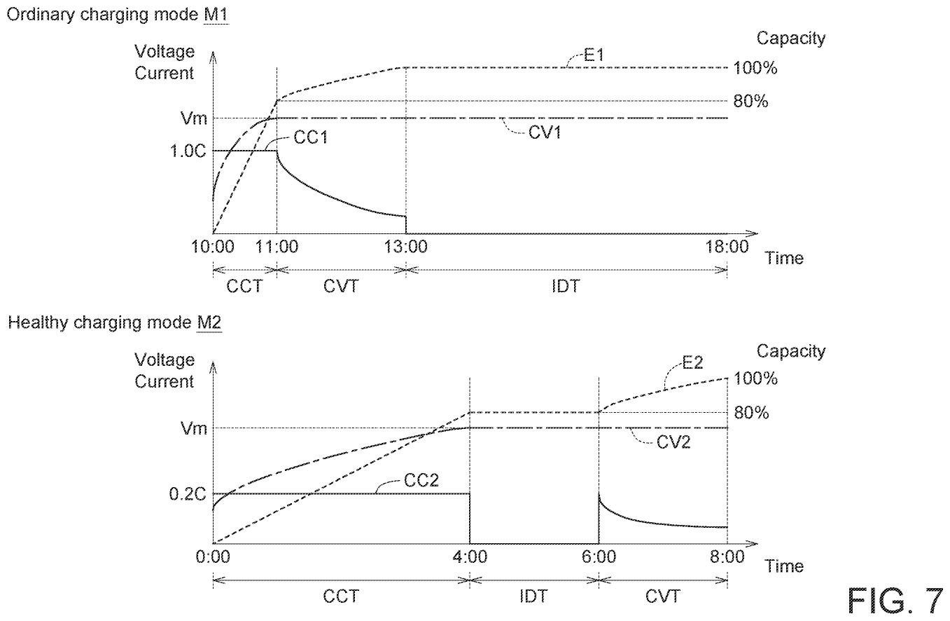

Referring to FIG. 6, an exemplification of a comparison between an ordinary charging mode M1 and a healthy charging mode M2 according to an embodiment is shown. Suppose that the circumstance that the predetermined total charging time TM within the predetermined busy period P1 is 8 hours. In the ordinary charging mode M1 illustrated in the upper diagram of FIG. 6, firstly, the battery is charged at a charge rate of 1C by constant current charging. For instance, the target capacity is 80%, and the predetermined constant current charging time CCT is 1 hours. Then, the battery is immediately charged by constant voltage charging until it reaches a capacity of 100%, and the predetermined constant voltage charging time CVT is 2 hours. Then, the battery remains at full capacity and the predetermined idle time IDT is 5 hours. In the ordinary charging mode M1, the battery remains at full capacity for long; the ordinary charging mode M1 is suitable for the predetermined busy period P1.

Suppose that the circumstance that the predetermined total charging time TM within the predetermined idle period P2 is 8 hours. In the healthy charging mode M2 illustrated in the lower diagram of FIG. 6, firstly, the battery is charged at a charge rate of 0.2C by constant current charging. For instance, the target capacity is 80%, and the predetermined constant current charging time CCT is 4 hours. Then, the capacity of 80% remains unchanged, and the predetermined idle time IDT is 2 hours. Lastly, the battery 120 is charged by constant voltage charging until it reaches a capacity of 100%, and the predetermined constant voltage charging time CVT is 2 hours. In the healthy charging mode M2, the battery is charged at a lower charge rate by constant current charging, and the constant voltage charging is performed after the idle action finishes, so that the battery 120 will not remain at full capacity for long; the healthy charging mode M2 is suitable for the predetermined idle period P2.

Referring to FIG. 7, a charging curve diagram of an ordinary charging mode M1 and a healthy charging mode M2 according to an embodiment is shown. Suppose that the battery is charged at 10.00 within the predetermined busy period P1. In the ordinary charging mode M1 illustrated in the upper diagram of FIG. 7, the charging current curve CC1 is controlled to be corresponding to a charge rate of 1C between 10.00 to 11.00 within the predetermined constant current charging time CCT; the charging voltage curve CV1 is controlled to be corresponding to a predetermined charging voltage Vm between 11.00 to 13.00 within the predetermined constant voltage charging time CVT; the capacity curve E1 is controlled to remain at 100% between 13.00 to 18.00 within the predetermined idle time IDT.

Suppose that the battery is charged between 00.00 and 08.00 within the predetermined idle period P2. In the healthy charging mode M2 illustrated at the lower diagram of FIG. 7, the control charging current curve CC2 is controlled to be corresponding to a charge rate of 0.2C between 00.00 to 04.00 within the predetermined constant current charging time CCT; the capacity curve E2 is controlled to remain at 80% between 04.00 to 06.00 within the predetermined idle time IDT; the charging voltage curve CV2 is controlled to remain at the predetermined charging voltage Vm between 06.00 to 08.00 within the predetermined constant voltage charging time CVT. The capacity curve E2 does not reach 100% until 08.00.

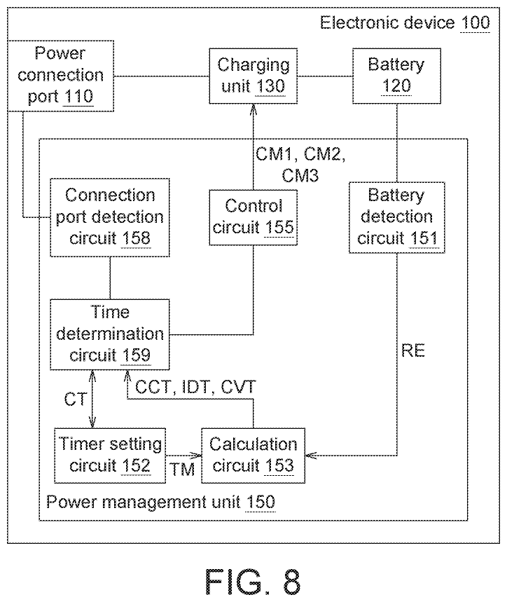

In the present embodiment, the electronic device 100 not only can perform the ordinary charging mode M1 within the predetermined busy period P1 but further can perform the healthy charging mode M2 within the predetermined idle period P2. Referring to FIG. 8, a block diagram of an electronic device 100 according to an embodiment is shown. The electronic device 100 includes a power connection port 110, the said battery 120, a charging unit 130 and a power management unit 150. The power management unit 150 includes a battery detection circuit 151, a timer setting circuit 152, a calculation circuit 153, a control circuit 155, a connection port detection circuit 158 and a time determination circuit 159. The power connection port 110 can be realized by such as a power cord jack, a magnetic interface, a wireless charging pad, or a Type-C connection port. The battery 120 can be realized by such as a lithium-ion battery, a lithium polymer battery, a nickel-cadmium battery, or a nickel-metal hydride battery. The charging unit 130, configured to charge the battery 120, can be realized by such as a circuit, a chip or a circuit board. The power management unit 150, configured to monitor the charging procedure, can be realized by such as a circuit, a chip or a circuit board.

In the present embodiment, through a timing arrangement of the constant current charging procedure and constant voltage charging procedure which are performed at a low charge rate, the battery 120 will not remain at full capacity for long in the healthy charging mode M2, so that the lifespan of the battery can be prolonged. Operations of each of the abovementioned elements are disclosed below with an accompanying flowchart.

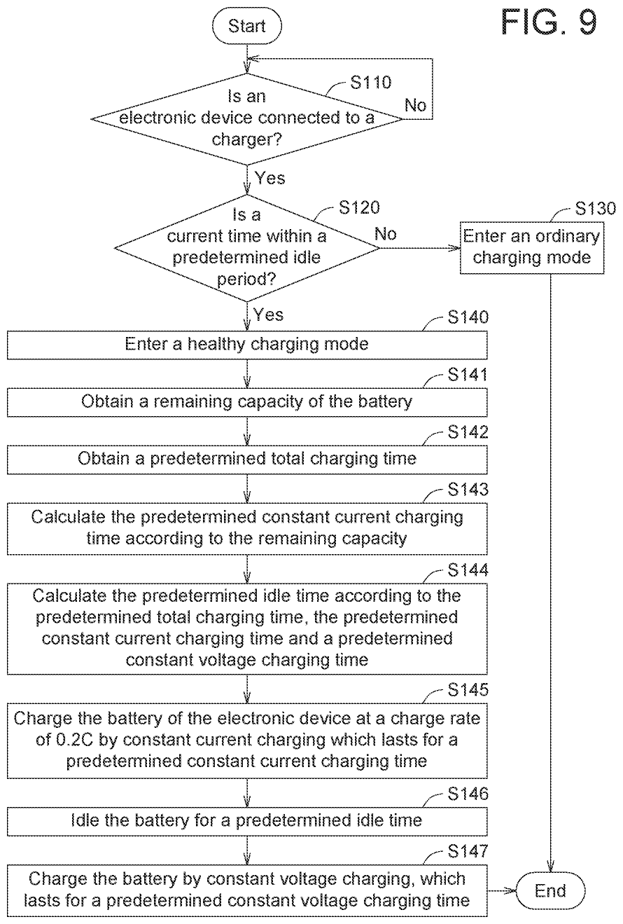

Referring to FIG. 9, a flowchart of a smart charging method according to an embodiment is shown. First, the method begins at step S110, as indicated in FIG. 8, whether the power connection port 110 of the electronic device 100 is connected to the charger 900 is determined by the connection port detection circuit 158. If it is determined that the power connection port 110 of the electronic device 100 is connected to the charger 900, the method proceeds to step S120.

Next, the method proceeds to step S120, as indicated in FIG. 8 and FIGS. 2 and 3, whether a current time CT is within the predetermined idle period P2 is determined by the time determination circuit 159. If it is determined that the current time is not within the predetermined idle period P2, the method proceeds to step S130; if it is determined that the current time CT is within the predetermined idle period P2, the method proceeds to step S140.

Then, the method proceeds to step S130, as indicated in FIG. 8 and FIG. 4, the battery 120 is controlled to enter an ordinary charging mode M1 by the power management unit 150.

Then, the method proceeds to step S140, as indicated in FIG. 8 and FIG. 4, the battery 120 is controlled to enter a healthy charging mode M2 by the power management unit 150.

Then, the method proceeds to step S141, as indicated in FIG. 8, a remaining capacity RE of the battery 120 is detected by the battery detection circuit 151. The battery detection circuit 151 detects the remaining capacity RE only when the battery 120 enters the healthy charging mode M2. Or, the battery detection circuit 151 periodically detects the remaining capacity RE then provides the detected remaining capacity RE when the battery 120 enters the healthy charging mode M2.

Then, the method proceeds to step S142, as indicated in FIG. 8 and FIG. 5, the predetermined total charging time TM is provided by the timer setting circuit 152. The timer setting circuit 152 calculates the predetermined total charging time TM according to the predetermined idle period P2 of FIG. 2 or FIG. 3.

Then, the method proceeds to step S143, as indicated in FIG. 8, the predetermined constant current charging time CCT is calculated by the calculation circuit 153 according to the remaining capacity RE.

Then, the method proceeds to step S144, as indicated in FIG. 8, the predetermined idle time IDT is calculated by the calculation circuit 153 according to the predetermined total charging time TM, the predetermined constant current charging time CCT and the predetermined constant voltage charging time CVT. The predetermined constant voltage charging time CVT is such as a fixed length of time.

Then, the method proceeds to step S145, as indicated in FIG. 8, a constant current control signal CM1 is outputted to the charging unit 130 by the control circuit 155, so that the charging unit 130 can charge the battery 120 of the electronic device 100 at a charge rate of 0.2C by constant current charging.

Then, the method proceeds to step S146, as indicated in FIG. 8, after the time determination circuit 159 determines that the predetermined constant current charging time CCT is over, an idle signal CM2 is outputted to the charging unit 130 by the control circuit 155, so that the charging unit 130 can idle the battery 120.

Then, the method proceeds to step S147, as indicated in FIG. 8, after the time determination circuit 159 determines that the predetermined idle time IDT is over, a constant voltage control signal CM3 is outputted to the charging unit 130 by the control circuit 155, so that the charging unit 130 can charge the battery by constant voltage charging, which lasts for a predetermined constant current charging time.

In the above embodiments, a constant current charging procedure with a low charge rate is adopted; the constant voltage charging procedure is performed after the idling action finishes, so that the battery 120 will not remain at full capacity for long in the healthy charging mode M2, and the lifespan of the battery can be prolonged.

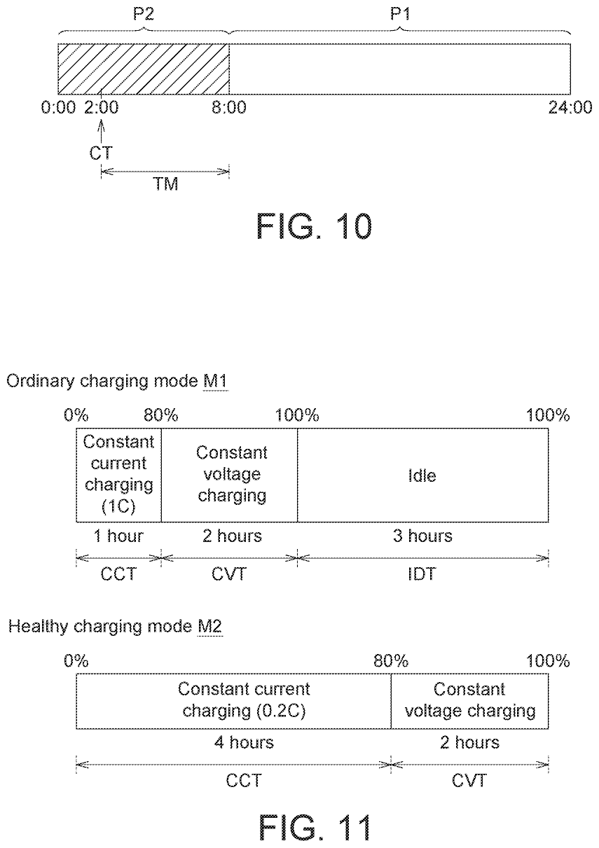

In another embodiment, when the predetermined total charging time TM is shorter, it is possible that the predetermined idle time IDT is 0. Referring to FIG. 10, another exemplification of predetermined total charging time TM is shown. If the current time CT is 02.00, the predetermined total charging time TM allowing charging within the predetermined idle period P2 is 6 hours.

Referring to FIG. 11, an exemplification of a comparison between an ordinary charging mode M1 and a healthy charging mode M2 according to another embodiment is shown. Suppose that the circumstance that the predetermined total charging time TM within the predetermined busy period P1 is 6 hours. In the ordinary charging mode M1 illustrated in the upper diagram of FIG. 11, firstly, the battery is charged at a charge rate of 1C by constant current charging. For instance, the target capacity is 80%, and the predetermined constant current charging time CCT is 1 hours. Then, the battery 120 is charged by constant voltage charging until it reaches a capacity of 100%, and the predetermined constant voltage charging time CVT is 2 hours. Then, the battery remains at full capacity, and the predetermined idle time IDT is 3 hours. In the ordinary charging mode M1, the battery remains at full capacity for long; the ordinary charging mode M1 is suitable for the predetermined busy period P1.

Suppose that the circumstance that the predetermined total charging time TM within the predetermined idle period P2 is 6 hours. In the healthy charging mode M2 illustrated in the lower diagram of FIG. 11, the battery is charged at a charge rate of 0.2C by constant current charging. For instance, the target capacity is 80%, and the predetermined constant current charging time CCT is 4 hours. Then, within the remaining 2 hours, the battery 120 is charged to a capacity of 100%, and the predetermined constant voltage charging time CVT is 2 hours. In the healthy charging mode M2, the battery is charged at a lower charge rate by constant current charging, and the constant voltage charging is performed last to avoid the battery 120 remaining full capacity for long; the healthy charging mode M2 is suitable for the predetermined idle period P2.

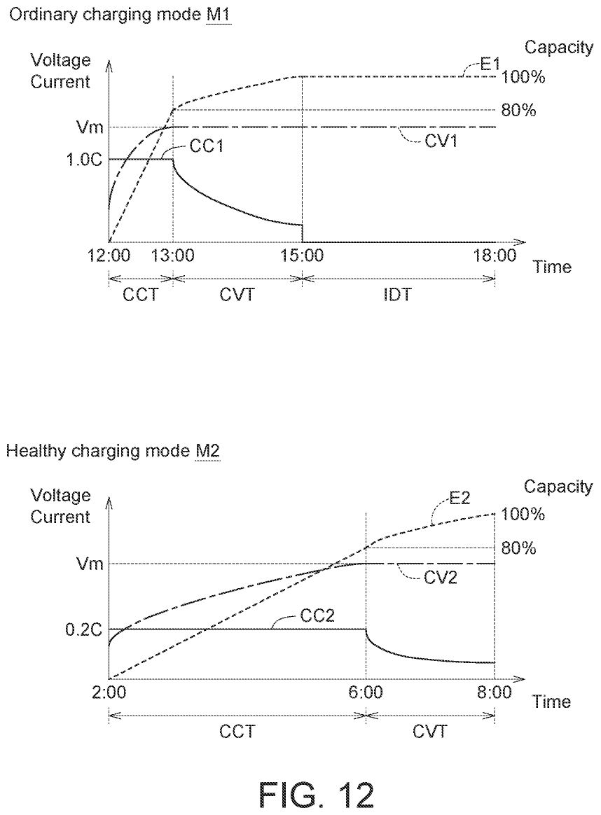

Referring to FIG. 12, an exemplification of a charging curve diagram of an ordinary charging mode M1 and a healthy charging mode M2 according to another embodiment is shown. Suppose that the battery is charged at 12.00 within the predetermined busy period P1. In the ordinary charging mode M1 illustrated in the upper diagram of FIG. 12, the charging current curve CC1 is controlled to be corresponding to a charge rate of 1C between 12.00 to 13.00 within the predetermined constant current charging time CCT; the charging voltage curve CV1 is controlled to be corresponding to a predetermined charging voltage Vm between 13.00 to 15.00 within the predetermined constant voltage charging time CVT; the capacity curve E1 is controlled to remain at 100% between 15.00 to 18.00 within the predetermined idle time IDT.

Suppose that the battery is charged between 02.00 to 08.00 within the predetermined idle period P2. In the healthy charging mode M2 illustrated in the lower diagram of FIG. 12, the charging current curve CC2 is controlled to be corresponding to a charge rate of 0.2C between 02.00 to 06.00 within the predetermined constant current charging time CCT; the charging voltage curve CV2 is controlled to be corresponding to a predetermined charging voltage Vm between 06.00 to 08.00 within the predetermined constant voltage charging time CVT. The capacity curve E2 does not reach 100% until 08.00.

In the above embodiments, a constant current charging procedure with a low charge rate is adopted. The constant voltage charging procedure is arranged to the last, so that the battery 120 will not remain at full capacity for long in a healthy charging mode M2 and the lifespan can be prolonged.

While the invention has been described by example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A smart charging method, comprising:
determining whether an electronic device is connected to a charger;
determining whether a current time is within a predetermined idle period, if the electronic device is connected to the charger;
charging a battery of the electronic device at a charge rate less than 0.8C by constant current charging, which lasts for a predetermined constant current charging time, if the current time is within the predetermined idle period;
idling the battery for a predetermined idle time, after the predetermined constant current charging time is over; and
charging the battery by constant voltage charging, after the predetermined idle time is over.

2. The smart charging method according to claim 1, wherein the after the predetermined constant current charging time is over, the capacity of the battery is below 80%.

3. The smart charging method according to claim 1, further comprising:
obtaining a remaining capacity of the battery;
obtaining a predetermined total charging time;
calculating the predetermined constant current charging time according to the remaining capacity; and
calculating the predetermined idle time according to the predetermined total charging time, the predetermined constant current charging time and a predetermined constant voltage charging time.

4. The smart charging method according to claim 3, wherein the step of obtaining the remaining capacity of the battery is performed at a healthy charging mode.

5. The smart charging method according to claim 3, wherein the step of obtaining the remaining capacity of the battery is periodically performed.

6. The smart charging method according to claim 1, wherein the constant voltage charging lasts for a predetermined constant voltage charging time, which remains unchanged.

7. The smart charging method according to claim 6, wherein the predetermined constant voltage charging time is 120 minutes.

8. The smart charging method according to claim 1, wherein the predetermined idle time is 0.

9. The smart charging method according to claim 1, wherein the predetermined idle time is larger than 0.

10. The smart charging method according to claim 1, wherein the battery has a non-charging mode, an ordinary charging mode and a healthy charging mode, before the charger is plugged into the electronic device, the battery is in the non-charging mode; when the charger is plugged into the electronic device within a predetermined busy period, the battery is controlled to remain in the ordinary charging mode; when the charger is plugged into the electronic device within the predetermined idle period, the battery is controlled to remain in the healthy charging mode.

11. An electronic device, comprising:
a power connection port, connected to a charger;
a battery;
a charging unit, connected to the battery and configured to charge the battery; and
a power management unit, connected to the power connection port and the battery, wherein the power management unit comprises:
a connection port detection circuit, configured to determine whether the power connection port is connected to the charger;
a time determination circuit; and
a control circuit, configured to control the charging unit;
wherein if the power connection port is connected to the charger, the time determination circuit determines whether a current time is within a predetermined idle period;
if the current time is within the predetermined idle period, the control circuit outputs a constant current control signal to the charging unit for enabling the charging unit to charge the battery at a charge rate less than 0.8C by constant current charging, which lasts for a predetermined constant current charging time;
after the time determination circuit determines that the predetermined constant current charging time is over, the control circuit outputs an idle signal to the charging unit for enabling the charging unit to idle the battery for a predetermined idle time;
after the time determination circuit determines that the predetermined idle time is over, the control circuit outputs a constant voltage control signal to the charging unit for enabling the charging unit to charge the battery by constant voltage charging.

12. The electronic device according to claim 11, wherein the after the predetermined constant current charging time is over, the capacity of the battery is below 80%.

13. The electronic device according to claim 11, wherein the power management unit further comprises:
a battery detection circuit, configured to detect a remaining capacity of the battery;
a timer setting circuit, configured to provide a predetermined total charging time; and
a calculation circuit, configured to calculate the predetermined constant current charging time according to the remaining capacity and calculate the predetermined idle time according to the predetermined total charging time, the predetermined constant current charging time and a predetermined constant voltage charging time.

14. The electronic device according to claim 13, wherein the remaining capacity of the battery is obtained at a healthy charging mode.

15. The electronic device according to claim 13, wherein the remaining capacity of the battery is periodically obtained.

16. The electronic device according to claim 13, wherein the constant voltage charging lasts for a predetermined constant voltage charging time, which remains unchanged.

17. The electronic device according to claim 16, wherein the predetermined constant voltage charging time is 120 minutes.

18. The electronic device according to claim 11, wherein the predetermined idle time is 0.

19. The electronic device according to claim 11, wherein the predetermined idle time is larger than 0.

20. The electronic device according to claim 11, wherein the battery has a non-charging mode, an ordinary charging mode and a healthy charging mode, before the charger is plugged into the electronic device, the battery is in the non-charging mode; when the charger is plugged into the electronic device within a predetermined busy period, the battery is controlled to remain in the ordinary charging mode; when the charger is plugged into the electronic device within the predetermined idle period, the battery is controlled to remain in the healthy charging mode.
